(19) United States
(12) Patent Application Publication
(10) Pub. No.: US 2016/0323860 A1
(43) Pub. Date: Nov. 3, 2016

(54) SYSTEMS AND METHODS FOR UPLINK SHARED CHANNEL CONTENT MANAGEMENT

(71) Applicant: QUALCOMM Incorporated, San Diego, CA (US)

(72) Inventors: Sharif Matin, San Diego, CA (US); Ramesh Chandra Chirala, San Diego, CA (US); Chulong Chen, San Jose, CA (US); Rajat Sharma, San Diego, CA (US)

(21) Appl. No.: 14/863,088

(22) Filed: Sep. 23, 2015

Related U.S. Application Data
(60) Provisional application No. 62/154,618, filed on Apr. 29, 2015.

(51) Int. Cl. H04W 72/04; H04L 5/00

(52) U.S. Cl. CPC H04W 72/044; H04L 5/0055

(57) ABSTRACT

Apparatuses and methods are described herein for managing communications in a wireless communication device, including, but not limited to determining failure to receive a first block, sending a signal as an indication for retransmission of systematic bits instead of sending a negative-acknowledgement (NACK) signal, and receiving a second block including the systematic bits.

### CROSS-REFERENCE TO RELATED PATENT APPLICATIONS

This application claims priority from Provisional U.S. Application No. 62/154,618 filed Apr. 29, 2015, incorporated herein by reference in its entirety.

### BACKGROUND

A wireless communication device, such as a mobile phone device or a smart phone, may include at least one SIM. Specifically, with respect to multi-SIM wireless communication devices, when all SIMs in a multi-SIM wireless communication device are active, the wireless communication device may be a multi-SIM-multi-active (MSMA) wireless communication device. When one SIM in a multi-SIM wireless communication device is active while the rest of the SIM(s) is standing by, the wireless communication device may be a multi-SIM-multi-standby (MSMS) wireless communication device. Each SIM enable a radio access technology (RAT), such as Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network.

Various call performance issues exist for multi-SIM or single-SIM wireless communication devices using one or more RATs. Such issues have been experienced with respect to a single-SIM wireless communication device using HSDPA and a multi-SIM wireless communication device using HSDPA and another RAT.

For example, with respect to a Duel Cell (DC)-HSDPA call, the call may be dropped absent of a High Speed-Shared Control Channel (HS-SCCH) order. When radio frequency (RF) resources are tuned away for communication via another RAT or when there is a network or hardware issue, information (e.g., the HS-SCCH order) may not be received. The HS-SCCH order is an indication relating to disabling/enabling of secondary carriers. A base station may send the HS-SCCH order 4 times (6 to 8 subframes apart). Regardless of whether the wireless communication device acknowledges (by sending an Acknowledgement (ACK) signal) or negative-acknowledges (by sending a Negative-acknowledgement (NACK) signal), the base station may nevertheless transition into a mode corresponding to the HS-SCCH order. Subsequently, the wireless communication device and the base station may be operating at different modes, therefore causing dropped calls.

In HSDPA, every transport block (TrBlk) associated with a given Hybrid Automatic Repeat-Request (HARQ) corresponds to a limited amount of repeated transmission, based on the value of the HARQ. In particular cases, a TrBlk may be retransmitted up to 4 times. When the wireless communication device fails to decode the TrBlk after 4 transmissions (or retransmissions), a residual Block Error Rate (BLER) has occurred. The base station, in response, ceases to retransmit the TrBlk. Upper layers such as the Radio Link Control (RLC) are, then, relied upon for recovering content of the TrBlk.

In particular, in a multi-SIM wireless communication device, the RF resources may be tuned away to perform communication activities (e.g., decode pages) for a RAT other than the HSDPA, while the RF resources may be engaged in on-going communication activities for the HSDPA. In other words, the HSDPA may collide with another RAT. The resulting collision may cause a failure to receive TrBlk HARQ. Decoding failure may occur as a consequence of the failure to receive the TrBlk HARQ. In addition, poor network qualities, co-existence issues, interference, or other RF-driven issues may also lead to decode failure in either single-SIM or multi-SIM wireless communication devices. Repeated decode failure, as described, may lead to Residual BLER, which may affect throughput and call stability, especially in Packet Switch (PS) and Signaling Radio Bearer (SRB) cases.

Furthermore, base stations may determine Physical Downlink Shared Channel (PDSCH) power control operation based on the BLER information (i.e., counts of NACK signals in High Speed-Dedicated Physical Control Channel (HS-DPCCH). The PDSCH power control operation can be used for TrBlk selection and PDSCH power allocation. The operating point with respect to BLER for HS-SCCH traffic (using PDSCH power control) is below 25% in most or all practical channel conditions. Favorable or ideal operating point with respect to BLER for a multi-SIM or single-SIM wireless communication device may be much greater.

Moreover, when the wireless communication device transmits a NACK signal in response to TrBlk decode failures, the base station may not retransmit systematic bits. For example, base stations may use an Incremental Redundancy (IR) combining approach concerning retransmission with HARQ. The IR combining approach relates to transmitting a subsequent TrBlk that may contain different information (based on a XRV value associated with the retransmitted TrBlk) as compared to the previous failed TrBlk. Therefore, successive retransmissions may not contain the systematic bits, which are used in decoding the content data. In other words, retransmitted TrBlks without systematic bits are not self-decodable. In particular cases, the retransmissions would not be able to pass the Cyclic Redundancy Check (CRC) when the wireless communication device fails to receive a first transmission (which contains the systematic bits) due to deep fade, tune away, network qualities, co-existence issues, interference, or other RF-driven issues. The wireless communication device may have to stand by for additional retransmissions, for the chance of obtaining the systematic bits as soon as possible.

In addition, blocks scheduled to be received by the wireless communication device at downlink may be wasted when the blocks are to be received during gaps caused by tune away (or other types of anticipatable RF resources unavailability interval). For example, a base station may be scheduled to transmit first-RAT block (e.g., Protocol Data Units (PDUs)) to the wireless communication device at downlink at a subframe even though the RF resources of the wireless communication device are unavailable to receive for the first RAT at the subframe (e.g., when the RF resources are used for a second RAT). Once the RF resources are tuned back to the first RAT, the RLC may be configured to recover all missing blocks (e.g., PDUs, including different overheads of Status PDUs, or the like) that was unable to be received. High amount of block recovery may negatively impact the application layer, by creating a back log of unrecovered blocks or even forcing the RLC to reset. Such issues are acute for longer gaps (e.g., longer tune away) because a larger time gap corresponds to more missing blocks.

### SUMMARY

Various embodiments relate to a method for managing communications, including sending a first signal for scheduling communication activities for a plurality of subframes and detecting unavailability of radio frequency (RF) resources. The method further includes determining at least one gap subframe in which the RF resources are unavailable and sending a second signal for refraining from scheduling communication activities for the gap subframes.

In some embodiments, detecting the unavailability of the RF resources includes detecting that the RF resources are expected be tuned away from a first radio access technology (RAT) to a second RAT. Determining the gap subframes in which the RF resources are unavailable includes determining one or more of the plurality of subframes in which the RF resources are expected be tuned away from the first RAT to the second RAT.

In various embodiments, the first RAT is at least one of Long Term Evolution (LTE), Code Division Multiple Access 1× Radio Transmission Technology (1×), Evolution-Data Optimized (EVDO), or High-Speed Downlink Packet Access (HSDPA).

In some embodiments, determining the unavailability of the RF resources includes determining whether a communication environment is expected to cross a predetermined threshold based on at least one of network qualities, co-existence issues, or interference. Determining the gap subframes in which the RF resources are unavailable includes determining one or more of the plurality of subframes in which the communication environment is expected to cross the predetermined threshold.

According to some embodiments, the first signal is sent in an uplink High Speed-Dedicated Physical Control Channel (HS-DPCCH).

According to various embodiments, the second signal is sent in an uplink HS-DPCCH.

In some embodiments, the first signal is a first channel quality indicator (CQI) determined based on communication channel quality.

In some embodiments, the second signal is a second CQI set to 0.

In various embodiments, the second signal is sent from a wireless communication device to a base station. The second signal requests the base station to refrain from scheduling to transmit to the wireless communication device at downlink during the gap subframes.

In some embodiments, the method further includes determining when the gap subframes are expected to end at downlink and sending the first signal at uplink in response to determining that the gap subframes have ended.

In further embodiments, sending the first signal at uplink in response to determining that the gap subframes have ended includes sending the first signal at an uplink subframe corresponding to one of the plurality of subframes after the last subframe of the gap subframes.

In some embodiments, the first signal and the second signal are sent at uplink from a wireless communication device to a base station.

According to some embodiments, each plurality of subframes is a downlink subframe.

In some embodiments, each of the at least one gap subframe is a HS-PDSCH subframe.

In various embodiments, a system is described for managing communications, the system including means for sending a first signal for scheduling communication activities for a plurality of subframes, means for detecting unavailability of RF resources, means for determining at least one gap subframe in which the RF resources are unavailable, and means for sending a second signal for refraining from scheduling communication activities for the gap subframes.

In some embodiments, a non-transitory computer readable-medium containing computer instructions such that, when executed, causes a processor to: send a first signal for scheduling communication activities for a plurality of subframes, detect unavailability of radio frequency (RF) resources, determine at least one gap subframe in which the RF resources are unavailable, and send a second signal for refraining from scheduling communication activities for the gap subframes.

According to various embodiments, a method for managing communications includes determining failure to receive a first block. The method further includes sending a signal as an indication for retransmission of systematic bits instead of sending a negative-acknowledgement (NACK) signal. The method further includes receiving a second block including the systematic bits.

In some embodiments, the method further includes decoding content data based on the systematic bits.

In some embodiments, the method further includes sending an acknowledgement signal in response to successfully receiving a third block prior to failing to receive the first block.

In various embodiments, the signal includes a null signal.

In some embodiments, sending the signal causes an identical retransmission of the first block.

In various embodiments, the second block is a retransmission of the first block. The second block is received in response to sending the signal.

In some embodiments, the signal is sent in an uplink High Speed-Dedicated Physical Control Channel (HS-DPCCH).

In some embodiments, the signal is a Discontinuous Transmission (DTX) sent in the HS-DPCCH to increase a number of retransmissions.

In various embodiments, the second block is received following the first block and in response to sending the signal.

According to various embodiments, the method further includes receiving the second block containing the systematic bits in response to sending the signal requesting for the retransmission of the systematic bits.

According to some embodiments, the first block and the second block are Signaling Radio Bearer (SRB) blocks. The method further includes determining a SRB message or procedure is expected based on a prior SRB message. The method further includes sending the signal requesting for retransmission of systematic bits in response to determining the SRB message is expected.

According to various embodiments, the first block and the second block are SRB blocks. The method further includes sending the signal requesting for retransmission of systematic bits when the first block has a size that less than a predetermined size.

According to various embodiments, the method further includes incrementally receiving retransmission of the first block from a base station to a wireless communication device by sending, with the wireless communication device, the signal requesting for retransmission of systematic bits in response to detecting, by the wireless communication device, a failure to receiving successive retransmissions of the first block. The signal includes a null signal.

In some embodiments, a wireless communication device includes at least one radio frequency (RF) resource and a processor coupled to the at least one RF resource, configured to connect to a first subscriber identity module (SIM) associated with a first subscription, and configured with processor-executable instructions to determine failure to receive a first block, send a signal requesting for retransmission of systematic bits instead of sending a negative-acknowledgement (NACK) signal, and receive a second block including the systematic bits.

In some embodiments, the processor is further configured with the processor-executable instructions to decode based on the systematic bits.

In some embodiments, the processor is further configured with the processor-executable instructions to send an acknowledgement signal in response to successfully receiving a third block prior to failing to receive the first block.

In various embodiments, the signal includes a null signal.

In some embodiments, sending the signal causes an identical retransmission of the first block.

In various embodiments, the second block is a retransmission of the first block. The second block is received in response to sending the signal.

In some embodiments, the signal is sent in an uplink High Speed-Dedicated Physical Control Channel (HS-DPCCH).

In some embodiments, the signal is a Discontinuous Transmission (DTX) sent in the HS-DPCCH to increase a number of retransmissions.

In various embodiments, the second block is received following the first block and in response to sending the signal.

According to various embodiments, the processor is further configured with the processor-executable instructions to receive the second block containing the systematic bits in response to sending the signal requesting for the retransmission of the systematic bits.

According to some embodiments, the first block and the second block are Signaling Radio Bearer (SRB) blocks. The processor is further configured to determine a SRB message or procedure is expected based on a prior SRB message. The processor is further configured with the processor-executable instructions to send the signal requesting for retransmission of systematic bits in response to determining the SRB message is expected.

According to various embodiments, the first block and the second block are SRB blocks. The processor is further configured to send the signal requesting for retransmission of systematic bits when the first block has a size that less than a predetermined size.

According to various embodiments, the processor is further configured to incrementally receive retransmission of the first block from a base station by sending the signal requesting for retransmission of systematic bits in response to detecting a failure to receiving successive retransmissions of the first block. The signal includes a null signal.

In some embodiments, a non-transitory computer readable-medium containing computer instructions for managing communications on a wireless communication device is described, such that, when the computer instructions are executed, a processor is caused to determine failure to receive a first block and send a signal requesting for retransmission of systematic bits instead of sending a NACK signal. The processor is further caused to receive a second block including the systematic bits.

According to various embodiments, a system for managing communications on a wireless communication device is described to include means for determining failure to receive a first block. The system further includes means for sending a signal requesting for retransmission of systematic bits instead of sending a NACK signal. The system further includes means for receiving a second block including the systematic bits.

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1 is a schematic diagram of a communication system in accordance with various embodiments.

FIG. 2 is a component block diagram of an example of a wireless communication device according to various embodiments.

FIG. 3 is a process flowchart diagram illustrating an example of a scheduling method according to various embodiments.

FIG. 4 is a schematic diagram illustrating an example of subframe selection according to various embodiments.

FIG. 5 is a process flowchart diagram illustrating an example of a scheduling method according to various embodiments.

FIG. 6 is a component block diagram of a wireless communication device suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some modern communication devices, referred to herein as a wireless communication device or mobile station (MS), may include any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such devices may include at least one subscriber identity modules (SIM), a programmable processor, memory, and circuitry for connecting to two or more mobile communication networks simultaneously.

A wireless communication device may include one or more SIMs that provide users of the wireless communication devices with access to one or multiple separate mobile communication networks. The mobile communication networks are supported by Radio Access Technologies (RATs). Examples of wireless communication devices include, but are not limited to, mobile phones, laptop computers, smart phones, and other mobile communication devices of the like that are configured to connect to one or more RATs. Examples of RATs include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network.

A wireless communication device provided with a plurality of SIMs and connected to two or more separate (or same) RATs using a same set of transmission hardware (e.g., Radio Frequency (RF) transceivers) is a multi-SIM-multi-standby (MSMS) communication device. In one example, the MSMS communication device may be a dual-SIM-dual-standby (DSDS) communication device, which may include two SIM cards/RATs that may both be on standby, but one is deactivated when the other one is in use. In another example, the MSMS communication device may be a triple-SIM-triple-standby (TSTS) communication device, which includes three SIM cards/RATs that may all be on standby, where two may be deactivated when the third one is in use. In other examples, the MSMS communication device may be other suitable multi-SIM communication devices, with, for example, four or more SIMs, such that when one is in use, the others may be deactivated.

On the other hand, a wireless communication device that includes a plurality of SIMs and connects to two or more separate (or same) RATs using two or more separate sets of transmission hardware is termed a multi-SIM-multi-active (MSMA) communication device. An example MSMA communication device is a dual-SIM-dual-active (DSDA) communication device, which includes two SIM cards/RATs. Both SIMs may remain active. In another example, the MSMA device may be a triple-SIM-triple-active (TSTA) communication device, which includes three SIM cards/RATs. All three SIMs may remain active. In other examples, the MSMA communication device may be other suitable multi-SIM communication devices with four or more SIMs, for which that all SIMs may be active.

Embodiments described herein relate to both a multi-SIM context (such as, but not limited to, the MSMS and MSMA contexts) as well as the single-SIM context.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and RATs supported by that network, correlate to one another.

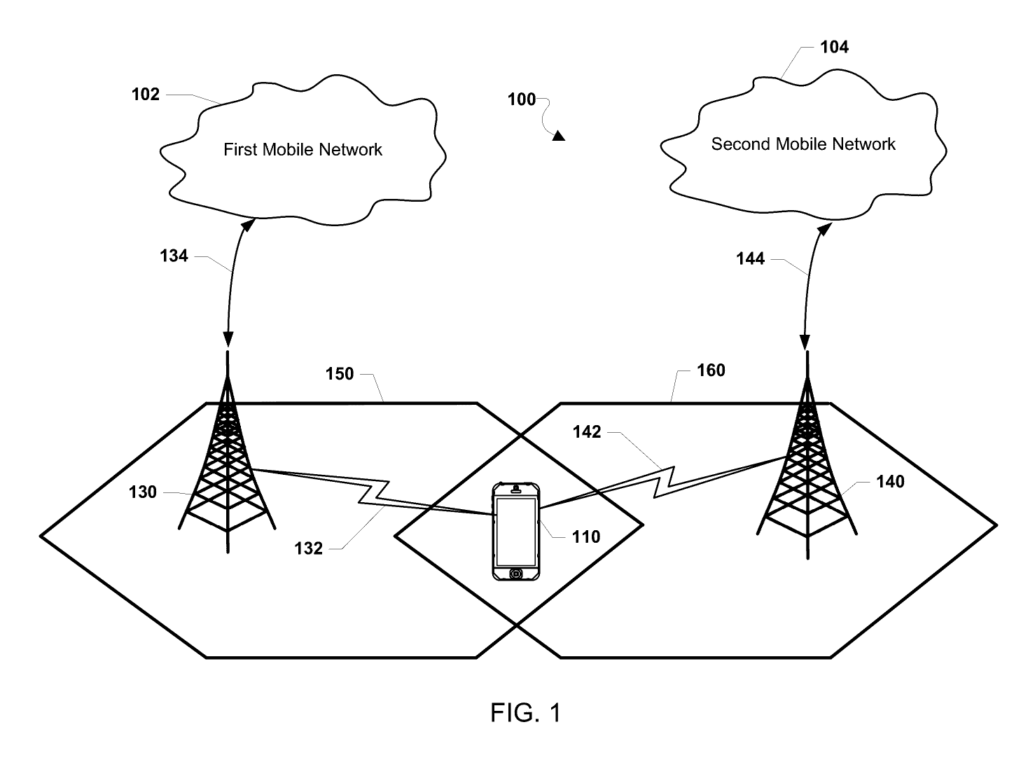

Various embodiments may be implemented within a communication system 100, an example of which is illustrated in FIG. 1. A first mobile network 102 and a second mobile network 104 typically each includes a plurality of cellular base stations (e.g., a first base station 130 a second base station 140, and the like). The first base station 130 may broadcast the first mobile network 102 in a first serving cell 150. The second base station 140 may broadcast the second mobile network 104 in a second serving cell 160. A wireless communication device 110 may be associated with the first serving cell 150, the second serving cell 160, or both.

The wireless communication device 110 may be in communication with the first mobile network 102 through a first cellular connection 132 to the first base station 130. The first cellular connection 132 may correspond to a first RAT of the wireless communication device 110. The wireless communication device 110 may also be in communication with the second mobile network 104 through a second cellular connection 142 to the second base station 140. The second cellular connection 142 may correspond to a second RAT of the wireless communication device 110, as in a multi-SIM context. The first base station 130 may be in communication with the first mobile network 102 over a wired or wireless connection 134. The second base station 140 may be in communication with the second mobile network 104 over a wired or wireless connection 144.

The first cellular connection 132 and the second cellular connection 142 may be made through two-way wireless communication links. Each of the wireless communication links may be enable by FDMA, TDMA, CDMA (particularly, EVDO), UMTS (particularly, WCDMA, LTE, HSDPA, and/or the like), GSM, 1×, GPRS, Wi-Fi, PCS, and/or another protocol used in a wireless communications network or a data communications network. By way of illustrating with a non-limiting example, the first cellular connection 132 may be a HSDPA connection. The second cellular connection 142 may be a connection associated with a RAT other than HSDPA. While WCDMA/HSDPA may be used as non-limiting examples herein as the first RAT, one of ordinary skill in the art would appreciate that embodiments concerning other RATs (e.g., LTE, EVDO, 1×, and the like) may be implemented in a manner similar to that described with respect to WCDMA/HSDPA. In some embodiments, the first cellular connection 132 and the second cellular connection 142 may each be associated with a different RAT. In other embodiments, the first cellular connection 132 and the second cellular connection 142 may be associated with a same RAT.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some embodiments, the first base station 130 and the second base station 140 may be an access point, Node B, evolved Node B (eNodeB or eNB), base transceiver station (BTS), or the like.

In various embodiments, the wireless communication device 110 may be configured to access the first mobile network 102 and the second mobile network 104 by virtue of the multi-SIM and/or the multi-mode SIM configuration of the wireless communication device 110 (e.g., via the first cellular connection 132 and the second cellular connection 142). When a SIM corresponding to a RAT is received, the wireless communication device 110 may access the mobile communication network associated with that RAT based on the information stored on the SIM.

While the wireless communication device 110 is shown connected to the mobile network 102 via two cellular connections, in some embodiments (not shown), the wireless communication device 110 may establish additional network connections associated in a manner similar to those described herein.

In some embodiments, the wireless communication device 110 may establish a wireless connection with a peripheral device (not shown) used in connection with the wireless communication device 110. For example, the wireless communication device 110 may communicate over a Bluetooth® link with a Bluetooth-enabled personal computing device (e.g., a “smart watch”). In some embodiments, the wireless communication device 110 may establish a wireless connection with a wireless access point (not shown), such as over a Wi-Fi connection. The wireless access point may be configured to connect to the Internet or another network over a wired connection.

While the communication system 100 is illustrated with two mobile networks 102, 104 for multi-SIM wireless communication devices, one of ordinary skill in the art would appreciate that the communication system 100 (in embodiments not shown) may include one mobile network (i.e., only the first mobile network 102 for the single-SIM wireless communication devices) or three or more mobile networks. Each mobile network may be a network such as, but not limited to, the first mobile network 102 or the second mobile network 104.

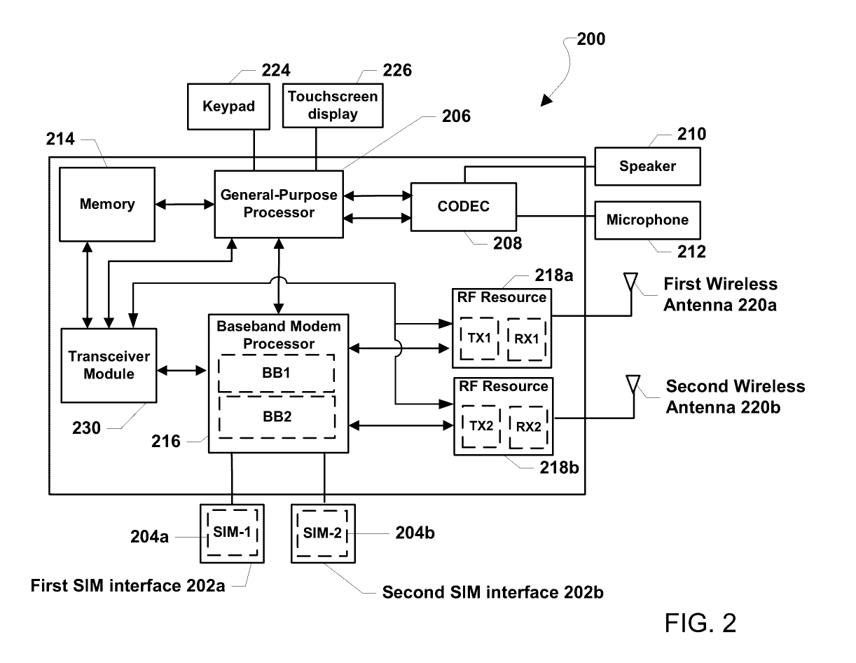

FIG. 2 is a functional block diagram of a wireless communication device 200 suitable for implementing various embodiments. According to various embodiments, the wireless communication device 200 may be the wireless communication device 110 as described with reference to FIG. 1. Referring to FIGS. 1-2, the wireless communication device 200 may include a first SIM interface 202a, which may receive a first SIM (SIM-1 204a) that is associated with the first RAT. The wireless communication device 200 may also include a second SIM interface 202b, which may receive a second SIM (SIM-2 204b) that is associated with the second RAT. In some embodiments, the first RAT may be different from the second RAT. In other embodiments, the first RAT may be THE same as the second RAT.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC Removable User Identity Module (R-UIM) or a CDMA Subscriber Identity Module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the wireless communication device 200, and thus need not be a separate or removable circuit, chip, or card.

A SIM used in various embodiments may store user account information, an IMSI, a set of SIM Application Toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may be a non-transitory processor-readable storage medium that stores processor-executable instructions. For example, the instructions may include routing communication relating to the first or second RAT though a corresponding baseband-RF resource chain. The memory 214 may include any suitable internal or external device for storing software and data. Examples of the memory 214 may include, but are not limited to, random access memory RAM, read only memory ROM, floppy disks, hard disks, dongles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to at least one baseband modem processor 216. Each SIM in the wireless communication device 200 (e.g., the SIM-1 202a and/or the SIM-2 202b) may be associated with a baseband-RF resource chain. A baseband-RF resource chain may include the baseband modem processor 216, which may perform baseband/modem functions for communications on at least one SIM. The baseband modem processor 216 may include one or more amplifiers and radios, referred to generally herein as RF resources 218a, 218b (e.g., the first RF resource 218a and the second RF resource 218b). In some embodiments, baseband-RF resource chains may share the baseband modem processor 216 (i.e., a single device that performs baseband/modem functions for all SIMs on the wireless communication device 200). In other embodiments, each baseband-RF resource chain may include physically or logically separate baseband processors (e.g., BB1, BB2). Alternatively, one baseband-RF resource chain may be shared by two or more of the RATs enabled by the SIMs 204a, 204b.

The RF resources 218a, 218b may each be transceivers that perform transmit/receive functions for the associated SIMs 204a, 204b of the wireless communication device 200. The RF resources 218a, 218b may include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

For simplicity, the first RF resource 218a (as well as the associated components) may be associated with the first RAT enabled by the SIM-1 202a. For example, the first RF resource 218a may be configured to transmit/receive via the first cellular connection 132. The second RF resource 218b may be associated with the second RAT as enabled by the SIM-2 202b. For example, the second RF resource 218b may be configured to transmit/receive via the second cellular connection 142.

In some embodiments, the general-purpose processor 206, the memory 214, the baseband modem processor 216, and the RF resources 218a, 218b may be included in the wireless communication device 200 as a system-on-chip. In some embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the wireless communication device 200 to enable communication between them, as is known in the art.

The wireless communication device 200 may include a transceiver module 230 configured to manage and/or schedule utilization of the RF resources 218a, 218b and/or the baseband modem processor 216. For example, the transceiver module 230 be configured perform the processes described herein with respect to communications and traffic.

In some embodiments, the transceiver module 230 may be implemented within the general-purpose processor 206 (or other component such as the baseband processor 216, or the like). For example, the transceiver module 230 may be implemented as a software application stored within the memory 214 and executed by the general-purpose processor 206. Accordingly, such embodiments can be implemented with minimal additional hardware costs. However, other embodiments relate to systems and processes implemented with dedicated hardware specifically configured for performing operations described herein with respect to the transceiver module 230. For example, the transceiver module 230 may be implemented as a separate hardware component (i.e., separate from the general-purpose processor 206). The transceiver module 230 may be coupled to the memory 214, the general processor 206, the baseband processor 216, and/or the RF resources 218a, 218b for performing the function described herein.

Hardware and/or software for the functions may be incorporated in the wireless communication device 200 during manufacturing, for example, as a part of a configuration of an Original Equipment Manufacturer (OEM) of the wireless communication device 200. In further embodiments, such hardware and/or software may be added to the wireless communication device 200 post-manufacture, such as by installing one or more hardware devices and/or software applications onto the wireless communication device 200.

In various embodiments, the wireless communication device 200 may include, among other things, additional SIM cards, SIM interfaces, a plurality of RF resources associated with the additional SIM cards, and additional antennas for connecting to additional mobile networks. In some embodiments, the wireless communication device 200 may include one baseband RF resource chain when the wireless communication device 200 includes one SIM. For example, a single-SIM wireless communication device may be the wireless communication device 200 without the second SIM interface 202b, the SIM-2 204b, the second RF resource 218b, and/or the second wireless antenna 220b.

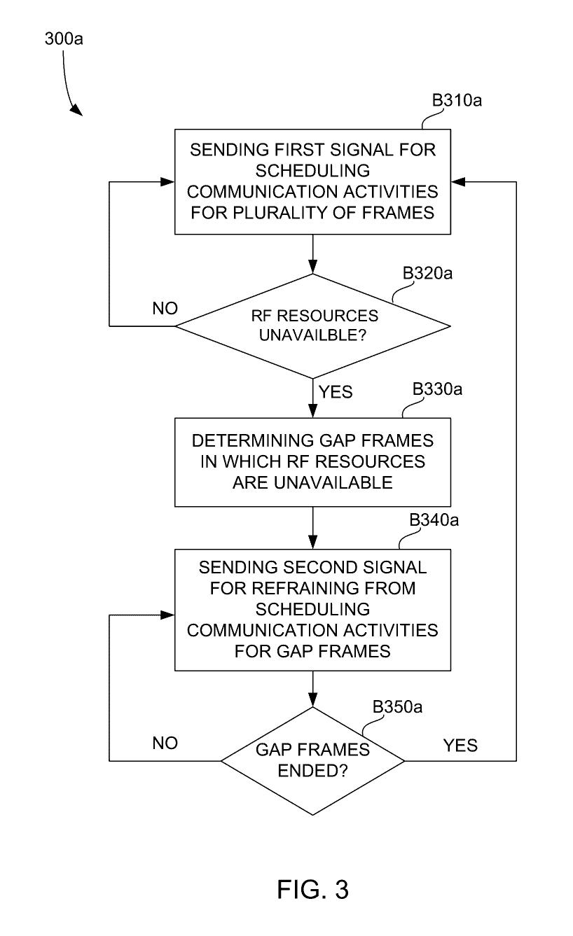

FIG. 3 is a process flowchart diagram illustrating an example of a scheduling method 300a according to various embodiments. Referring to FIGS. 1-3, the scheduling method 300a may be performed by the transceiver module 230 of the wireless communication device 200 according to some embodiments.

At block B310a, the transceiver module 230 may be configured to send a first signal for scheduling communication activities for a plurality of subframes (alternatively, frames, slots, or the like). The plurality of subframes may be subframes associated with High Speed-Physical Downlink Shared Channel (HS-PDSCH). The first signal may be a normal Channel Quality Indicator (CQI) determined in conventional manners. For example, the CQI may be information related to communication channel quality. The communication channel quality may be measured based on parameters such as, but not limited to, Bit Error Rate (BER), Signal-to-Noise Ratio (SNR), Received Signal Strength Indication (RSSI), a combination thereof, and/or the like. The first signal may be transmitted, in uplink High Speed-Dedicated Physical Control Channel (HS-DPCCH), from the wireless communication device 200 to the base station (e.g., the first base station 130) associated with HSDPA (e.g., the first RAT).

Next, at block B320a, the transceiver module 230 may be configured to determine whether the RF resources (e.g., one or more or all of the RF resources 218a, 218b, the baseband modem processor 216, the antennas 220a, 220b, and/or the like) may become unavailable (anticipated to be unavailable) for any of the plurality of subframes. For example, the RF resources may become unavailable in a multi-SIM wireless communication device (in both RF-resources-sharing and non-RF-resources-sharing RF resources cases) when the RF resources associated with the HSDPA are being tuned away from the HSDPA to another RAT. In another example, the RF resources may become unavailable in a multi-SIM wireless communication device when there is a co-existence issue between the two sets of RF resources or when the communication environment is determined to be poor (below a predetermined threshold using suitable assessing parameters). In yet another example, the RF resources may become unavailable in a single-SIM wireless communication device when the network quality is determined to be poor or when interference from various originals is determined to exceed a predetermined threshold.

In response to the transceiver module 230 determining that the RF resources are expected to be available (B320a:NO), the transceiver module 230 may continue to send, in uplink HS-DPCCH, the first signal for scheduling communication activities for the plurality of subframes at block B310a. On the other hand, in response to the transceiver module 230 determining that the RF resources are expected to be unavailable (B320:YES), the transceiver module 230 may be configured to determine gap subframes in which the RF resources are expected to be unavailable at block B330a.

Illustrating with a non-limiting example concerning multi-SIM wireless communication devices, the RF resources may be temporarily tuned away from HSDPA to perform communication activities (e.g., but not limited to receiving pages) for another RAT. The transceiver module 230 may determine the tune-away in advance. Based on the time interval in which the RF resources are expected to be tuned away, the transceiver module 230 may determine at least one of the plurality of HS-PDSCH subframes that will be affected by the tune away. Similarly, communication environment such as coexistence issues, interference, expected network quality may also be determined ahead. Based on the expected communication environment, the transceiver module 230 may determine corresponding HS-PDSCH subframes that will be affected by the inadequate communication environment. In addition, a mapping may be determined by the transceiver module 230 between each of the gap subframes (HS-PDSCH subframes) and one or more corresponding uplink HS-DPCCH subframes, which may be used to transmit the CQIs.

Next at block B340a, the transceiver module 230 may be configured to send a second signal for refraining from scheduling communication activities for the gap subframes. The second signal may be a manipulated CQI. That is, instead of transmitting the normal CQI (i.e., the first signal, which may be based on communication channel quality), the transceiver module 230 may transmit the manipulated CQI in the uplink HS-DPCCH to the base station.

The base station typically may use the CQI received from the wireless communication device 200 to schedule block transmission for the upcoming HS-PDSCH subframes. When the CQI having the value of “0” is received by the base station, the base station may typically not schedule HS-SCCH/HS-PDSCH on the upcoming subframes until a non-zero CQI is received from the wireless communication device 200. In other words base station may stop scheduling for the wireless communication device 200 upon reception of CQI=“0.”

Accordingly, no or less information may be transmitted by the base station during the interval in which RF resources are unavailable. As a result, when the RF resources are tuned back to the first RAT (e.g., HSDPA), the RLC may be tasked to recover less or no missing information as compared to otherwise. This, in turn, reduces the back log of unrecovered data. In addition, since the base station may stop scheduling for the wireless communication device 200 from first receiving CQI=“0” until a non-zero CQI is received again, any HS-SCCH orders intended to be sent during this time may be postponed by the base station until the time the non-zero CQI is received again from the wireless communication device 200. This could reduce the chance of the wireless communication device 200 missing out the HS-SCCH orders during the duration its RF resource is unavailable.

Next at block B350a, the transceiver module 230 may determine whether the gap subframes are expected to end. For example, when the gap subframes are expected to end and the next one of the plurality of subframes would benefit from the availability of the RF resources (B350a:NO), the transceiver module 230 may send, in an uplink HS-DPCCH subframe, the first signal (normal CQI) for scheduling communication activities for a corresponding HS-PDSCH subframe at block B310a. On the other hand, when the gap subframes are determined to be on-going, the transceiver module 230 may continue to send the second signal (CQI=“0”) (B350a:NO), in an uplink HS-DPCCH subframe, for refraining from scheduling communication activities for the gap subframes (a corresponding HS-PDSCH subframe) at block B340a.

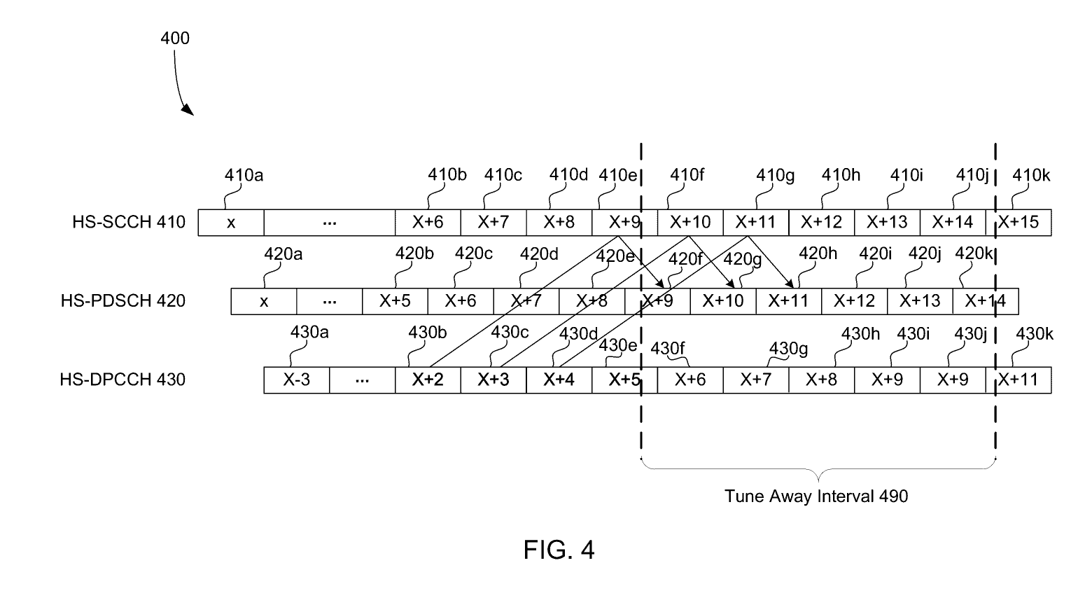

FIG. 4 is a schematic diagram 400 illustrating an example of subframe selection according to various embodiments. The schematic diagram 400 may correspond to one or more of the blocks in FIG. 3. With reference to FIGS. 1-4, the schematic diagram 400 illustrates High Speed-Shared Control Channel (HS-SCCH) activity 410, including HS-SCCH subframes (e.g., HS-SCCH subframe[x] 410a, HS-SCCH subframe[x+6] 410b, . . . , and HS-SCCH subframe[x+15] 410k). The schematic diagram 400 also illustrates HS-PDSCH activity 420, including HS-PDSCH subframes (e.g., HS-PDSCH subframe[x] 420a, HS-PDSCH subframe[x+5] 420b, . . . , and HS-PDSCH subframe[x+14] 420k). The schematic diagram 400 further illustrates HS-DPCCH activity 430, including HS-DPCCH subframes (e.g., HS-DPCCH subframe[x-3] 430a, HS-DPCCH subframe[x+2] 430b, . . . , and HS-DPCCH subframe[x+11] 430k). The HS-SCCH activity 410, HS-PDSCH activity 420, and HS-DPCCH activity 430 are laid out with respect to time.

A tune away interval 490 may be determined by the transceiver module 230 in the manner described. During the tune away interval 490, all of the transmission and reception activities (e.g., the HS-SCCH activity 410, HS-PDSCH activity 420, and HS-DPCCH activity 430) associated with the HSDPA may collide with activities for another RAT and are dropped temporarily from the RF resources. Though tuning away (causing the tune away interval 490) is used in the non-limiting example of the schematic diagram 400, one of ordinary skill in the art would appreciate that other types of events causing the unavailability of the RF resources may have similar impact.

With respect to HS-PDSCH activity 420, HS-PDSCH subframe[x+9] 420f to HS-PDSCH subframe[x+14] 420k may be affected by the collision with another RAT in the tune away interval 490. For example, when the base station sends blocks to the wireless communication device 200 in HS-PDSCH subframe[x+9] 420f to HS-PDSCH subframe[x+14] 420k, the wireless communication device 200 may not be able to receive due to the tune away. To trigger the base station to refrain from sending any information in one or more of the HS-PDSCH subframe[x+9] 420f to HS-PDSCH subframe[x+14] 420k, the transceiver module 230 may be configured to transmit the manipulated CQI (CQI=“0”) via one or more of HS-DPCCH subframes, each corresponding to one of the HS-PDSCH subframe[x+9] 420f to HS-PDSCH subframe[x+14] 420k.

In particular, after determining that HS-PDSCH subframe[x+9] 420f to HS-PDSCH subframe[x+14] 420k may be affected by the tune away interval 490, the transceiver module 230 may determine a corresponding HS-DPCCH subframe. For example, the HS-DPCCH subframe[x+2] 430b may be determined to correspond to the HS-PDSCH subframe [x+9] 420f. The manipulated CQI transmitted in the HS-DPCCH subframe[x+2] 430b to the base station may be received by the base station at the HS-SCCH subframe[x+9] 410e. The time difference between the HS-DPCCH subframe[x+2] 430b and the HS-SCCH subframe[x+9] 410e may be attributed to known processing time, local latency, network latency, error rate, a combination thereof, and/or the like with respect to the wireless communication device 200 and/or the base station.

After receiving the manipulated CQI, the base station may determine to not transmit any signals to the wireless communication device 200 in HS-SCCH subframe[x+9] 410e, based on the manipulated CQI. The HS-SCCH subframe[x+9] 410e may correspond to the HS-PDSCH subframe[x+9] 420f (also based on known processing time, local latency, network latency, error rate, a combination thereof, and/or the like). In other words, the HS-DPCCH subframe[x+2] 430b corresponds to the HS-SCCH subframe[x+9] 410e, which in turn corresponds to the HS-PDSCH subframe[x+9] 420f. Given such mapping, the HS-DPCCH subframe[x+2] 430b (and similarly, HS-DPCCH subframe[x+3] 430c and HS-DPCCH subframe[x+4] 430d) is determined to carry the modified CQI. In other embodiments, a HS-DPCCH subframe may be directly mapped to a HS-PDSCH subframe.

Given that within the tune away interval 490, the wireless communication device 200 may not transmit any signal (e.g., manipulated CQI) due to collision, HS-DPCCH subframe[x+5] 430e to HS-DPCCH subframe[x+8] 430h may not transmit manipulated CQI to indicate to the base station to refrain from sending data.

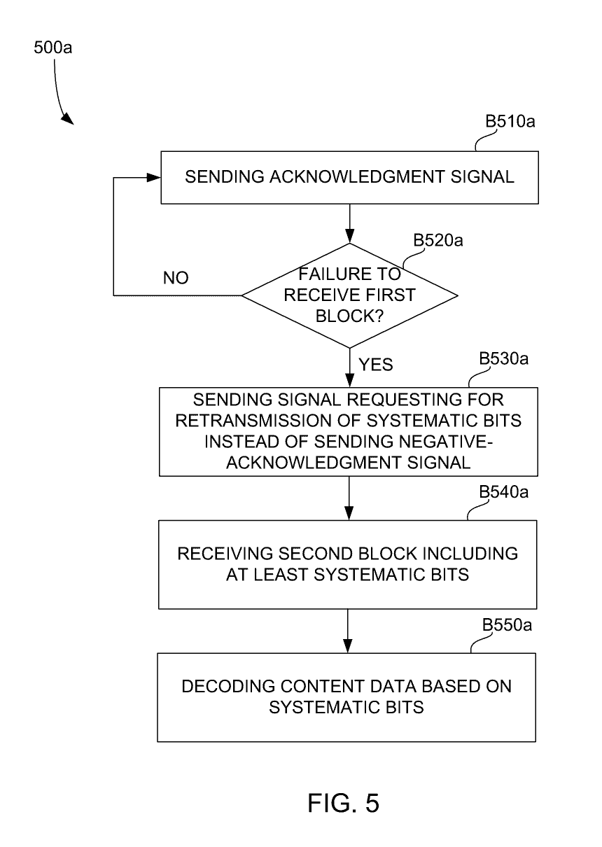

FIG. 5 is a process flowchart diagram illustrating an example of a scheduling method 500a according to various embodiments. Referring to FIGS. 1-5, the scheduling method 500a may be performed by the transceiver module 230 of the wireless communication device 200 according to some embodiments.

At block B510a, the transceiver module 230 may be configured to send Acknowledgement (ACK) signals when the transceiver module 230 determines that a block has been successfully received. For example, successful reception may be based on passing the Cyclic Redundancy Check (CRC).

Next at block B520a, the transceiver module 230 may determine whether there is a failure to receive a first block in a HARQ reception. The first block may include at least systematic bits used to decode content data. For example, unsuccessful reception may be based on failing the CRC. Here, transmission failure may be caused by the unavailability of the RF resources as described. In response to the transceiver module 230 determining that the first block is successfully received (B520a:NO), the transceiver module 230 may send the ACK signal at block B510a. On the other hand, In response to the transceiver module 230 determining that there is a failure in receiving the first block (B520a:YES), the transceiver module 230 may send a signal requesting for retransmission of systematic bits instead of sending a Negative-Acknowledgement (NACK) signal at block B530a. The signal may be sent in the HS-DPCCH. In some embodiments, the signal requesting for retransmission of systematic bits may be a null signal, instead of the NACK signal. The ACK, NACK, and null signals are feedback signals.

In further embodiments, the signal requesting for retransmission of systematic bits may be a Discontinuous Transmission (DTX) signal. Sending the DTX signal in HS-DPCCH may increase HARQ retransmissions to avoid Residual BLER of any TrBlk under any HARQ ID. The transceiver module 230 may easily monitor such through checking the XRV values.

In response to the wireless communication device 200 sending the signal requesting for retransmission of systematic bits instead of the NACK signal for the first transmission failure, the base station may send the originally transmitted first block, which may include the systematic bits. Accordingly, sending a null signal instead of the NACK signal can avoid standing by for successive HARQ retransmissions that are not identical to the first block and may not contain the systematic bits.

Thus, at block B540a, the transceiver module 230 may receive a second block including at least the systematic bits. The base station may retransmit the first block as the second block in response to receiving the signal requesting for retransmission of systematic bits. The second block may be identical to the first block. Accordingly, following the failure to receive the first block, the next block received by the wireless communication device 200 may be the second block, triggered by sending the signal requesting for retransmission of systematic bits. Next at block B550a, the transceiver module 230 may decode the content data using the systematic bits included in the second block.

In some embodiment, block B520a may be triggered in response to the transceiver module 230 determining that two or more previous decode failures (instead of one) occurred. For example, block B520a (and the subsequent blocks B510a, B530a, B540a, B550a) may be triggered at a third or fourth iteration of retransmission, at which point the Residual BLER is about to occur. The transceiver module 230 may track the number of iterations of retransmission by monitoring the XRV values of the scheduling on different HARQs.

Methods described herein may be especially beneficial for Signaling Radio Bearer (SRB) data, which may be associated with high priority because SRB indicates layers configurations for the wireless communication device 200. Therefore, it is especially important to avoid transmission/reception failure for SRB data. Given that SRB may also be time sensitive, expediting the retransmission mechanism with HARQ-level extra retransmissions may be faster than any Unified Layer 2 (L2) initiated retransmission. In some embodiments, the method 500a may be implemented for the SRB blocks when the wireless communication device 200 determines that a SRB message or procedure (e.g., an active set update, reconfiguration message, and the like) may be expected due to at least one prior uplink SRB message (e.g., a Measurement Report Message (MRM) or another message sequence). In other embodiments, the method 500a may be implemented when detecting a block associated with a HARQ having a Transport Block Size (TBS) less than a predetermined number of bytes. Given that SRB blocks are transmitted in isolation and therefore are sent with lower TBS as compared to other types of blocks, SRB block may be identified accordingly for implementing the method 500a.

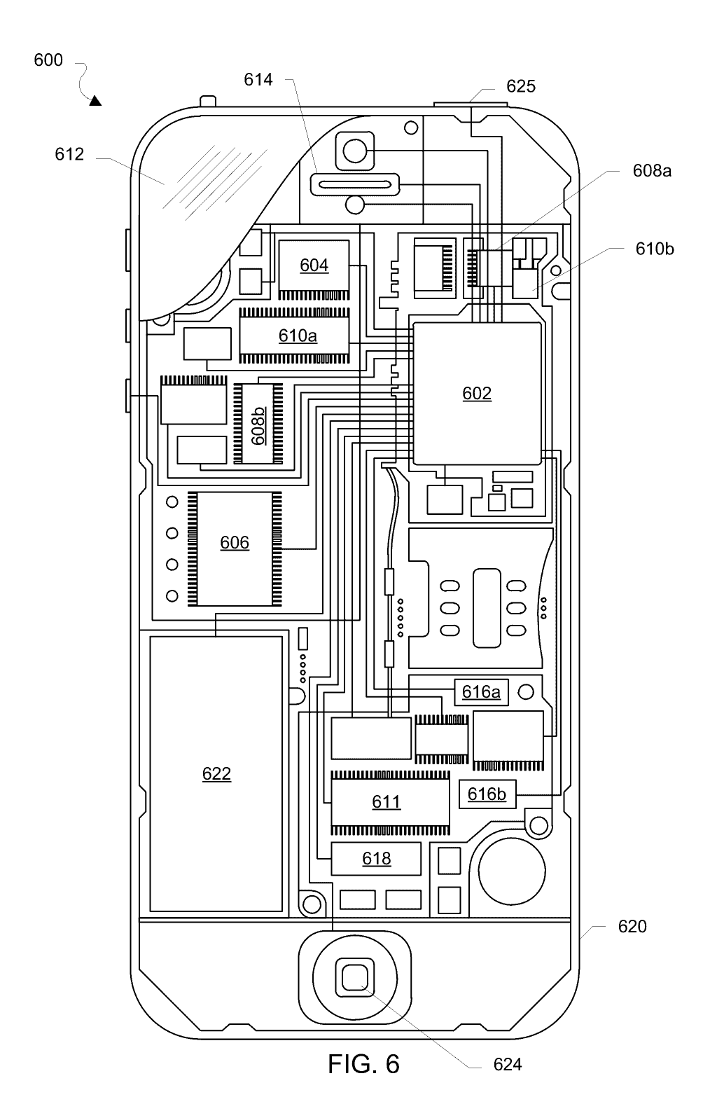

The various embodiments may be implemented in any of a variety of wireless communication device 200, an example of which is illustrated in FIG. 6, as a wireless communication device 600. As such, the wireless communication device 600 may implement the process and/or the apparatus of FIGS. 1-5, as described herein.

With reference to FIGS. 1-6, the wireless communication device 600 may include a processor 602 coupled to a touchscreen controller 604 and an internal memory 606. The processor 602 may be one or more multi-core integrated circuits designated for general or specific processing tasks. The memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the wireless communication device 600 need not have touch screen capability.

The wireless communication device 600 may have one or more cellular network transceivers 608a, 608b coupled to the processor 602 and to two or more antennas 610 and configured for sending and receiving cellular communications. The transceivers 608 and antennas 610a, 610b may be used with the above-mentioned circuitry to implement the various embodiment methods. The cellular network transceivers 608a, 608b may be the RF resources 218a, 218b. The antennas 610a, 610b may be the antennas 220a, 220b. The wireless communication device 600 may include two or more SIM cards 616a, 616b, corresponding to SIM-1 204a and SIM-2 204b, coupled to the transceivers 608a, 608b and/or the processor 602. The wireless communication device 600 may include a cellular network wireless modem chip 611 (e.g., the baseband modem processor 216) that enables communication via at least one cellular network and is coupled to the processor 602.

The wireless communication device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown).

The wireless communication device 600 may also include speakers 614 for providing audio outputs. The wireless communication device 600 may also include a housing 620, constructed of a plastic, metal, or a combination of materials, for containing all or some of the components discussed herein. The wireless communication device 600 may include a power source 622 coupled to the processor 602, such as a disposable or rechargeable battery. The rechargeable battery may also be coupled to a peripheral device connection port (not shown) to receive a charging current from a source external to the wireless communication device 600. The wireless communication device 600 may also include a physical button 624 for receiving user inputs. The wireless communication device 600 may also include a power button 626 for turning the wireless communication device 600 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for managing communications on a wireless communication device, comprising:
determining failure to receive a first block;
sending a signal as an indication for retransmission of systematic bits instead of sending a negative-acknowledgement (NACK) signal; and
receiving a second block including the systematic bits.

2. The method of claim 1, further comprising decoding content data based on the systematic bits.

3. The method of claim 1, further comprising sending an acknowledgement signal in response to successfully receiving a third block prior to failing to receive the first block.

4. The method of claim 1, wherein the signal comprises a null signal.

5. The method of claim 1, wherein sending the signal causes an identical retransmission of the first block.

6. The method of claim 1,
wherein the second block is a retransmission of the first block; and
wherein the second block is received in response to sending the signal.

7. The method of claim 1, wherein the signal is sent in an uplink High Speed-Dedicated Physical Control Channel (HS-DPCCH).

8. The method of claim 7, wherein the signal is a Discontinuous Transmission (DTX) sent in the HS-DPCCH to increase a number of retransmissions.

9. The method of claim 1, wherein the second block is received following the first block and in response to sending the signal.

10. The method of claim 1, further comprising receiving the second block containing the systematic bits in response to sending the signal requesting for the retransmission of the systematic bits.

11. The method of claim 1, wherein the first block and the second block are Signaling Radio Bearer (SRB) blocks, the method further comprising:
determining a SRB message or procedure is expected based on a prior SRB message; and
sending the signal requesting for retransmission of systematic bits in response to determining the SRB message is expected.

12. The method of claim 1, wherein the first block and the second block are Signaling Radio Bearer (SRB) blocks, the method further comprising sending the signal requesting for retransmission of systematic bits when the first block has a size that less than a predetermined size.

13. The method of claim 1, further comprising: incrementally receiving retransmission of the first block from a base station to the wireless communication device by sending, with the wireless communication device, the signal requesting for retransmission of systematic bits in response to detecting, by the wireless communication device, a failure to receiving successive retransmissions of the first block, wherein the signal comprises a null signal.

14. A wireless communication device, comprising:
at least one radio frequency (RF) resource;
a processor coupled to the at least one RF resource, configured to connect to a first subscriber identity module (SIM) associated with a first subscription, and configured with processor-executable instructions to:
determine failure to receive a first block;
send a signal requesting for retransmission of systematic bits instead of sending a negative-acknowledgement (NACK) signal; and
receive a second block including the systematic bits.

15. The wireless communication device of claim 14, wherein the processor is further configured with the processor-executable instructions to decode content data based on the systematic bits.

16. The wireless communication device of claim 14, wherein the processor is further configured with the processor-executable instructions to send an acknowledgement signal in response to successfully receiving a third block prior to failing to receive the first block.

17. The wireless communication device of claim 14, wherein the signal comprises a null signal.

18. The wireless communication device of claim 14, wherein sending the signal causes an identical retransmission of the first block.

19. The wireless communication device of claim 14,
wherein the second block is a retransmission of the first block; and
wherein the second block is received in response to sending the signal.

20. The wireless communication device of claim 14, wherein the signal is sent in an uplink High Speed-Dedicated Physical Control Channel (HS-DPCCH).

21. The wireless communication device of claim 20, wherein the signal is a Discontinuous Transmission (DTX) sent in the HS-DPCCH to increase a number of retransmissions.

22. The wireless communication device of claim 14, wherein the second block is received following the first block and in response to sending the signal.

23. The wireless communication device of claim 14, the processor is further configured with the processor-executable instructions to receive the second block containing the systematic bits in response to sending the signal requesting for the retransmission of the systematic bits.

24. The wireless communication device of claim 14, wherein the first block and the second block are Signaling Radio Bearer (SRB) blocks, the processor is further configured with the processor-executable instructions to:
determine a SRB message or procedure is expected based on a prior SRB message; and
send the signal requesting for retransmission of systematic bits in response to determining the SRB message is expected.

25. The wireless communication device of claim 14, wherein the first block and the second block are Signaling Radio Bearer (SRB) blocks, the processor is further configured with the processor-executable instructions to send the signal requesting for retransmission of systematic bits when the first block has a size that less than a predetermined size.

26. The wireless communication device of claim 14, the processor is further configured with the processor-executable instructions to incrementally receive retransmission of the first block from a base station by sending the signal requesting for retransmission of systematic bits in response to detecting a failure to receiving successive

27. A non-transitory computer readable-medium containing computer instructions for managing communications on a wireless communication device, such that, when the computer instructions are executed, a processor is caused to:
determine failure to receive a first block;
send a signal requesting for retransmission of systematic bits instead of sending a negative-acknowledgement (NACK) signal; and
receive a second block including the systematic bits.

28. A system for managing communications on a wireless communication device, comprising:
means for determining failure to receive a first block;
means for sending a signal requesting for retransmission of systematic bits instead of sending a negative-acknowledgement (NACK) signal; and
means for receiving a second block including the systematic bits.
